(19) United States
(12) Patent Application Publication
(10) Pub. No.: US 2012/0322542 A1
(43) Pub. Date: Dec. 20, 2012

(54) METHODS AND APPARATUS FOR PROVIDING AN ADAPTIVE GAMING MACHINE DISPLAY

(75) Inventors: Russell Chudd, Reno, NV (US); Charles Johnson, Reno, NV (US); Tai Rosander, Reno, NV (US); Stewart Thoeni, Reno, NV (US)

(73) Assignee: IGT, Reno, NV (US)

(21) Appl. No.: 13/162,358

(22) Filed: Jun. 16, 2011

(51) Int. Cl. A63F 13/00

(52) U.S. Cl. 463/25

(57) ABSTRACT

Disclosed herein are techniques for providing an adaptive gaming machine. In some implementations, a spatial coordinate of an eye area of a player in proximity to the electronic gaming machine may be determined. The spatial coordinate may define a location of the eye area in relation to the electronic gaming machine. Based on the identified eye location, a preferred viewing area of a display screen associated with the electronic gaming machine may be determined. A determination may be made as to whether a game play portion of the video data is positioned within the preferred viewing area of the display screen. When the game play portion of the video data is not positioned within the preferred viewing area of the display screen, the game play portion of the video data may be positioned within the preferred viewing area of the display screen.

### TECHNICAL FIELD

The present disclosure relates generally to wager-based gaming machines, and more specifically to adaptive gaming machines.

### BACKGROUND

There are a wide variety of associated devices that can be connected to a gaming machine such as a slot machine or video poker machine. Some examples of these devices are lights, ticket printers, card readers, speakers, bill validators, ticket readers, coin acceptors, display panels, key pads, coin hoppers and button pads. Many of these devices are built into the gaming machine or components associated with the gaming machine such as a top box which usually sits on top of the gaming machine.

Typically, utilizing a master gaming controller, the gaming machine controls various combinations of devices that allow a player to play a game on the gaming machine and also encourage game play on the gaming machine. For example, a game played on a gaming machine usually requires a player to input money or indicia of credit into the gaming machine, indicate a wager amount, and initiate a game play. These steps require the gaming machine to control input devices, including bill validators and coin acceptors, to accept money into the gaming machine and recognize user inputs from devices, including key pads and button pads, to determine the wager amount and initiate game play. After game play has been initiated, the gaming machine determines a game outcome, presents the game outcome to the player and may dispense an award of some type depending on the outcome of the game.

### SUMMARY

Various embodiments described or referenced herein are directed to different devices, methods, systems, and computer program products for providing an adaptive gaming machine. In some embodiments, devices, methods, systems, and computer program products may be configured or designed for use in a casino environment.

In some implementations, an electronic gaming machine may include an input device configured to receive an indication of value for play of a wager-based game in which one or more game outcomes can be provided responsive to a wager. The electronic gaming machine may also include an output device configured to output an indication of value in association with play of the wager-based game. The electronic gaming machine may also include a display screen configured to display video data associated with the wager-based game. The electronic gaming machine may also include an electronic sensor configured to determine a spatial coordinate of an eye area of a player in proximity to the electronic gaming machine, the spatial coordinate defining a location of the eye area in relation to the electronic gaming machine. The electronic gaming machine may also include one or more processors.

In some implementations, the one or more processors may be configured to control play of the wager-based game, provide the video data to the display screen, and/or determine a preferred viewing area of the display screen based on the spatial coordinate. The one or more processors may also be configured to determine whether a game play portion of the video data is positioned within the preferred viewing area of the display screen. The one or more processors may also be configured to position, when the game play portion of the video data is not positioned within the preferred viewing area of the display screen, the game play portion of the video data within the preferred viewing area of the display screen.

In some implementations, the spatial coordinate may include an indication of a height of the eye area. The spatial coordinate may include an indication of a location of the eye area in three dimensional space in relation to the electronic gaming machine. The electronic sensor may be an optical sensor. Determining the spatial coordinate for the eye area may include determining a location of the player's head and/or determining an orientation of the player's head.

In some implementations, the one or more processors may be configured to determine whether the player has left the proximity of the electronic gaming machine and, when the player has left the proximity of the electronic gaming machine, position the game play portion of the video data at a default position on the display screen. The one or more processors may also be configured to determine a preferred mechanical position of a mechanically adjustable portion of the electronic gaming machine based on the spatial coordinate and/or position the mechanically adjustable portion of the electronic gaming machine at the preferred mechanical position. The one or more processors may also be configured to determine a height estimate of the player's height based on the spatial coordinate and/or transmit the height estimate to be stored on a storage medium.

### BRIEF DESCRIPTION OF THE DRAWINGS

The included drawings are for illustrative purposes and serve only to provide examples of possible structures and process steps for the disclosed inventive systems and methods for providing an adaptive gaming machine. These drawings in no way limit any changes in form and detail that may be made to embodiments by one skilled in the art without departing from the spirit and scope of the disclosure.

FIGS. 1, 2A, and 2B shows perspective diagrams of a gaming machine 2, configured in accordance with one implementation.

FIG. 3 shows a flow diagram of a method 300 for adjusting an electronic gaming machine, performed in accordance with one implementation.

FIG. 4 shows a flow diagram of a method 400 for communicating biometric data at an electronic gaming machine, performed in accordance with one implementation.

FIG. 5 shows a flow diagram of a method 500 for adjusting a display screen at an electronic gaming machine, performed in accordance with one implementation.

FIG. 6 shows a server-based (Sb™) gaming network, configured in accordance with some implementations.

### DETAILED DESCRIPTION

Applications of systems and methods according to one or more embodiments are described in this section. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosure, it is understood that these examples are not limiting, such that other embodiments may be used and changes may be made without departing from the spirit and scope of the disclosure.

In some implementations, techniques described herein may facilitate the automatic adjustment of a gaming machine in accordance with a player's biometric information, such as the location and/or orientation of a player's eye area. The gaming machine may perform one or more a digital or mechanical adjustments to adapt the gaming machine to the player's specific needs. For example, one or more sensors at the gaming machine may be used to determine a location and/or orientation of the player's head, eyes, face, or facial features. Then, the gaming machine may move an emphasized portion of information displayed on a display screen, such as a portion showing game play outcomes, to an area of the display screen estimated to be directly in front of a player's eyes. Alternately, or additionally, other mechanical or digital adjustments to the gaming machine may be made, such as adjusting the positions or orientations of speakers, chairs, button panels, displays, or other portions of the gaming machine in order to better suit the player.

Some gaming machines and their accompanying components such as chairs are designed to fit a player of average height. While satisfying the majority of players, this “one size fits all” approach may compromise the ergonomics of the machine for at least some players. For example, a gaming machine configured for use by a person of average sized may present ergonomic difficulties for players who are significantly shorter or taller than average. As another example, such a gaming machine may present ergonomic difficulties for players who are disabled in some way.

Many gaming machines employ liquid crystal displays (LCDs). However, many LCD displays have limited viewing angles. For example, a Thin Film Transistor (TFT) based LCD may be rated with a viewing angle range of between 80 degrees and 89 degrees. A player viewing the LCD from a location outside of this range may have difficult seeing the content displayed on the LCD. Further, an image presented on the LCD may vary in features such as brightness and contrast even when viewed from angles within the rated viewing range. For example, image quality can vary with viewing angle from a very bright, sharp image when viewed normal to the LCD to a somewhat washed out appearance when viewed from an angle. In this case, a person taller or shorter than average will see an image of compromised quality in a given display due to their skewed viewing angle. As a result, the game may not appear as appealing to a person taller or shorter than average as it would to an average height player. These problems may be more apparent in gaming machines with large display screens, such as a vertically-oriented LCD screen larger than 40 inches.

Many gaming machines include speakers. In some gaming machines, speakers are directed at a location estimated to be the head or ear position of an average player at the gaming machine. In this way, the impact of the sounds output from the speakers may be increased. The resulting sound may be heard loudest at a general location when the average player is positioned to play the machine. In some gaming machines, the speakers are situated in a location above most players' heads. Because of the angled downward direction of such speakers, sound energy is aimed at the casino floor, which may have carpeting or rugs to facilitate sound absorption. In this way, less sound is broadcast or reflected in a horizontal or upward direction away from the gaming machine. Thus, less sound energy is wasted competing with banks of machines in the vicinity, and excess volume does not pollute the acoustical environment of the casino floor. However, directional speakers may not be positioned in an effective way to present sound to players significantly shorter or taller than average.

In some implementations, a gaming machine may be configured with one or more sensors to sense the location of a player's head, face, or facial features. The sensors may be mounted in the cabinet, outside the cabinet, on the main door, on the top box, in a player tracking component region, in the gaming machine seat, or in any other area of the gaming machine. This information may be used to adjust the presentation of the game.

In some implementations, a preferred viewing area of a display screen may be determined based on the location or orientation of the player's head, face, or eyes. The preferred viewing area of a display screen may be a region designated for enhanced game intensity based on its central location within a player's current or ergonomically correct field of vision. For example, the center of attention of the game may be placed at the preferred viewing area of the display screen. When a region of a display screen is designated for enhanced game intensity, action in bordering areas may be reduced. This reduction in surrounding action may decrease distraction, thereby increasing a feeling of immersion in the game.

In some implementations, a preferred speaker configuration may be determined based on the location or orientation of the player's head, face, or ears. The preferred speaker configuration may include a preferred positioning or orientation of mechanical speakers, a preferred volume level for various speakers associated with the electronic gaming machine, or a preferred activation state for various speakers associated with the electronic gaming machine. The preferred speaker configuration may be activated to enhance the player's experience at the gaming machine and to increase a feeling of immersion in the game.

In some implementations, a player's height may be determined. For example, the player's height may be detected by a sensor at a gaming machine. As another example, the player's height may be determined (e.g., by measurement, by identification card, etc.) by a casino employee when the player creates a player tracking profile. The player's height may be stored in association with the player's player tracking number. Then, one or more gaming machine components or game play elements may be adjusted in accordance with the player's height when the player is identified at a gaming machine.

In some implementations, a configurable feature at the gaming machine, such as a focal area or center of intensity, may be automatically adjusted. The adjustment setting may be stored and associated with the player's player tracking account. For example, the adjustment setting may be retrieved for use with a gaming machine not equipped with biometric sensors.

In some implementations, a player may manually adjust a configurable feature at the gaming machine, such as a focal area or center of intensity. For example, the player may provide user input at a user input device on the gaming machine. The position preference may be stored and associated with the player's player tracking account.

In some implementations, one or more sensors may be used to detect biometric data such as a player's skin temperature or facial expressions. Such data may be used to estimate a player's mood or temperament. The estimate may be used to adjust game play, lighting, sound, or other features at the gaming machine to further enhance the player's experience and extend play time. For example, if the player's mood is estimated as bored, then the gaming machine may initiate special video sequences, animations, or other effects designed to capture the player's attention. As another example, if the player's mood is estimated as negative or sad, the gaming machine may initiate special effects designed to improve the player's mood.

In some implementations, one or more sensors may be used to determine if the player is leaving or has left the gaming machine. For example, one or more cameras, optical sensors, weight sensors, infrared sensors, or ultrasonic sensors may be used to detect the player's presence at the gaming machine. When the player is leaving the gaming machine, the gaming machine may initiate special effects to reward the player, to attract the player's attention, or to entice the player to return later. Once a player has left a gaming machine, the gaming machine may return to a default presentation state. This default presentation state may function as an attract mode to attract players to the gaming machine.

In some implementations, a gaming machine may include one or more sensing devices to sense information about the player. For example, a gaming machine may include a camera, IR emitter and receiver, ultrasonic emitter and receiver, or other sensing device. Sensor components may be packaged discretely and incorporated into the design of the gaming machine in a concealed manner. Alternately, sensor components may be readily apparent to a player.

In some implementations, the sensing devices may interface with a controller, may interface with a gaming machine processor, or may interface with a server via a network. Interpretation of the device signals may be performed by the controller, the gaming machine processor, or the server.

In some implementations, the signals may be used to create instructions for adjusting the presentation of the game at the gaming machine. For example, the signals may be used to reposition an image on a display. As another example, the signals may be used to adjust game play, lights, sounds, volume, volatility, brightness, other outputs of gaming machine components, or other properties of those outputs. As yet another example, the signals may be used to create instructions for driving stepper motors, linear actuators, or other mechanical devices to physically adjust the position of the LCD, button panel, lights, speakers, and other mechanically adjustable portions of the gaming machine.

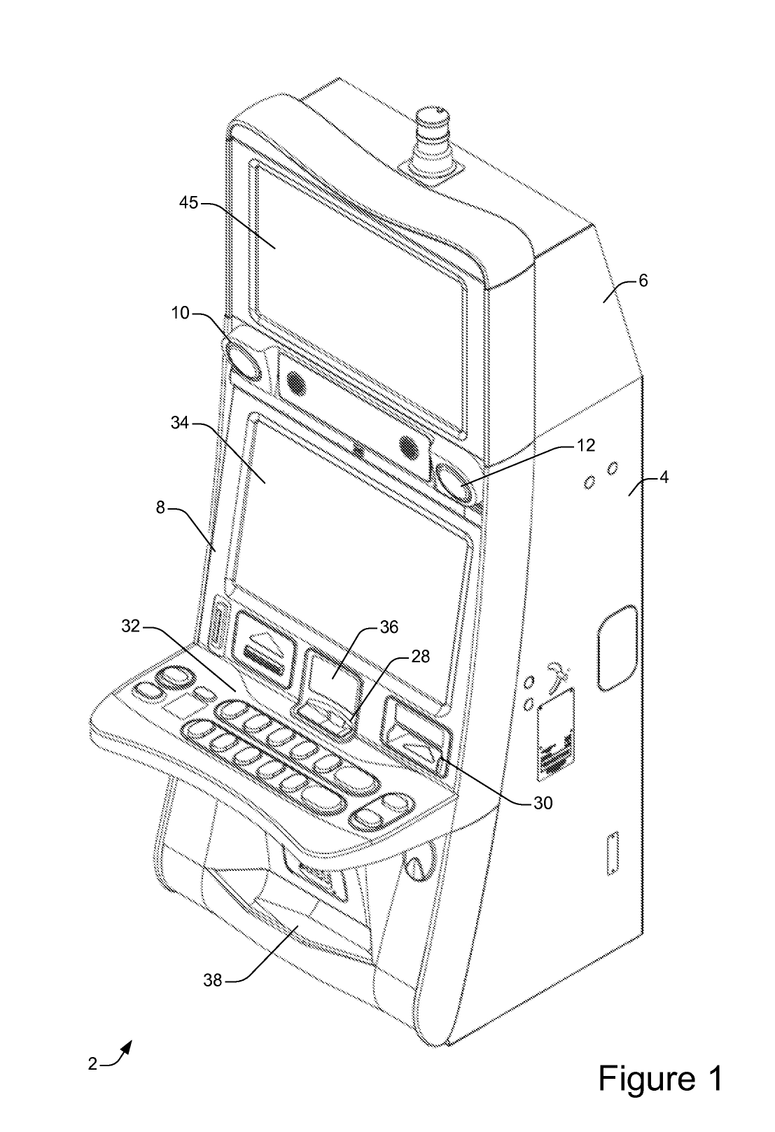

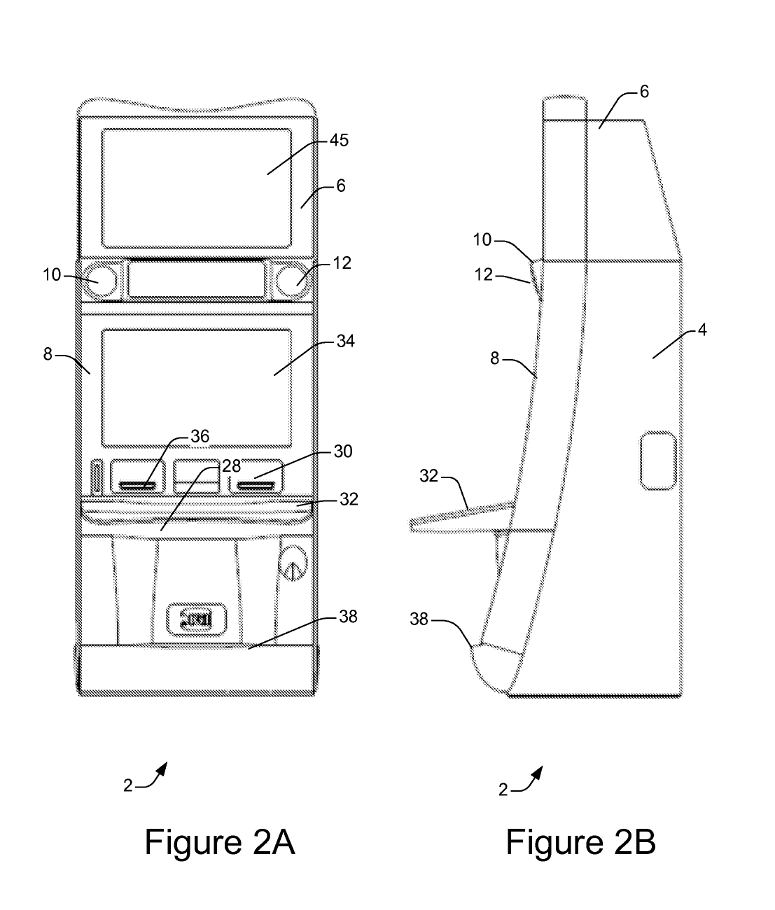

FIGS. 1, 2A, and 2B shows perspective diagrams of a gaming machine 2, configured in accordance with one implementation. As illustrated in FIGS. 1, 2A, and 2B, gaming machine 2 includes a main cabinet 4, which generally surrounds the machine interior and is viewable by users. The main cabinet includes a main door 8 on the front of the machine, which opens to provide access to the interior of the machine.

In some implementations, the electronic gaming machine may include any of a plurality of devices. For example, the electronic gaming machine may include a ticket printer that prints bar-coded tickets, a key pad for entering player tracking information, a display (e.g., a video display screen) for displaying player tracking information, a card reader for entering a magnetic striped card containing player tracking information, and any other devices. The ticket printer may be used to print tickets for a cashless ticketing system. In FIGS. 1-2B, attached to the main door is a payment acceptor 28, a bill validator 30, and a coin tray 38. The payment acceptor may include a coin slot and/or a payment, note, or bill acceptor, where the player inserts money, coins, tokens, or other types of payments.

In some implementations, devices such as readers or validators for credit cards, debit cards, smart cards, or credit slips may facilitate payment. For example, a player may insert an identification card into a card reader of the gaming machine. The identification card may be a smart card coded with a player's identification, credit totals (or related data) and other relevant information. As another example, a player may carry a portable device, such as a cell phone, a radio frequency identification tag or any other suitable wireless device. The portable device may communicates a player's identification, credit totals (or related data), and/or any other relevant information to the gaming machine. As yet another example, money may be transferred to a gaming machine through electronic funds transfer. When a player funds the gaming machine, a another logic device coupled to the gaming machine may determine the amount of funds entered and display the corresponding amount on a display device.

In some implementations, attached to the main door are a plurality of player-input switches or buttons 32. The input switches can include any suitable devices which enables the player to produce an input signal which is received by the processor. The input switches may include a game activation device that may be used by the player to start any primary game or sequence of events in the gaming machine. The game activation device can be any suitable play activator such as a “bet one” button, a “max bet” button, or a “repeat the bet” button. In some instances, upon appropriate funding, the gaming machine may begin the game play automatically. Alternately, the gaming machine may automatically activate game play after detecting user input via the game activation device.

In some implementations, one input switch is a cash-out button. The player may push the cash-out button and cash out to receive a cash payment or other suitable form of payment corresponding to the number of remaining credits. For example, when the player cashes out, the player may receive the coins or tokens in a coin payout tray. As another example, the player may receive other payout mechanisms such as tickets or credit slips redeemable by a cashier (or other suitable redemption system) or funding to the player's electronically recordable identification card. As yet another example, funds may be transferred from the gaming machine to the player's smart card.

In some implementations, one input switch is a touch-screen coupled with a touch-screen controller, or some other touch-sensitive display overlay to enable for player interaction with the images on the display. The touch-screen and the touch-screen controller may be connected to a video controller. A player may make decisions and input signals into the gaming machine by touching the touch-screen at the appropriate places. One such input switch is a touch-screen button panel.

In some implementations, the gaming machine may include communication ports for enabling communication of the gaming machine processor with external peripherals, such as external video sources, expansion buses, game or other displays, a SCSI port, a key pad, or a network interface for communicating via a network.

In some implementations, the gaming machine may include a label area, such as the label area 36. The label area may be used to display any information or insignia related to activities conducted at the gaming machine.

In some implementations, the electronic gaming machine may include one or more display devices. For example, the electronic gaming machine 2 includes display devices 34 and 45. The display devices 34 and 45 may each include any of a cathode ray tube, an LCD, a light emitting diode (LED) based display, an organic light emitting diode (OLED) based display, a polymer light emitting diode (PLED) based display, an SED based-display, an E-ink display, a plasma display, a television display, a display including a projected and/or reflected image, or any other suitable electronic display device.

In some implementations, the display devices at the gaming machine may include one or more electromechanical devices such as one or more rotatable wheels, reels, or dice. The display device may include an electromechanical device adjacent to a video display, such as a video display positioned in front of a mechanical reel. The display devices may include dual-layered or multi-layered electromechanical and/or video displays that cooperate to generate one or more images. The display devices may include a mobile display device, such as a smart phone or tablet computer, that allows play of at least a portion of the primary or secondary game at a location remote from the gaming machine. The display devices may be of any suitable size and configuration, such as a square, a rectangle or an elongated rectangle.

In some implementations, the display devices of the gaming machine are configured to display game images or other suitable images. The images may include symbols, game indicia, people, characters, places, things, faces of cards, dice, and any other images. The images may include a visual representation or exhibition of the movement of objects such as mechanical, virtual, or video reels and wheel. The images may include a visual representation or exhibition of dynamic lighting, video images, or any other images.

In some implementations, the electronic gaming machine may include a top box. For example, the gaming machine 2 includes a top box 6, which sits on top of the main cabinet 4. The top box 6 may house any of a number of devices, which may be used to add features to a game being played on the gaming machine 2. These devices may include speakers 10 and 12, display device 45, and any other devices. Further, the top box 6 may house different or additional devices not illustrated in FIGS. 1-2B. For example, the top box may include a bonus wheel or a back-lit silk screened panel which may be used to add bonus features to the game being played on the gaming machine. As another example, the top box may include a display for a progressive jackpot offered on the gaming machine. As yet another example, the top box may include a smart card interaction device. During a game, these devices are controlled and powered, at least in part, by circuitry (e.g. a master gaming controller) housed within the main cabinet 4 of the machine 2.

In some implementations, speakers may be mounted and situated in the cabinet with an angled orientation toward the player. For instance, the speakers 10 and 12 located in top box area 6 of the upper region of gaming machine 2 may be mounted and situated in the cabinet with an angled orientation down towards the player and the floor. In one example, the angle is 45 degrees with respect to the vertical, longitudinal axis of machine 2. In another example, the angle is in a range of 30-60 degrees. In another example, the angle is any angle between 0 and 90 degrees. In some implementations, the angle of speakers in the gaming machine may be adjustable. For instance, speakers may be adjusted to face in a direction more closely approximating an estimated position of a player's head or facial features.

The bill validator 30, player-input switches 32, display screen 34, and other gaming devices may be used to present a game on the game machine 2. The devices may be controlled by code executed by a master gaming controller housed inside the main cabinet 4 of the machine 2. The master gaming controller may include one or more processors including general purpose and specialized processors, such as graphics cards, and one or more memory devices including volatile and non-volatile memory. The master gaming controller may periodically configure and/or authenticate the code executed on the gaming machine.

In some implementations, the gaming machine may include a sound generating device coupled to one or more sounds cards. The sound generating device may include one or more speakers or other sound generating hardware and/or software for generating sounds, such as playing music for the primary and/or secondary game or for other modes of the gaming machine, such as an attract mode. The gaming machine may provide dynamic sounds coupled with attractive multimedia images displayed on one or more of the display devices to provide an audio-visual representation or to otherwise display full-motion video with sound to attract players to the gaming machine. During idle periods, the gaming machine may display a sequence of audio and/or visual attraction messages to attract potential players to the gaming machine. The videos may also be customized for or to provide any appropriate information.

In some implementations, the gaming machine may include a sensor, such as a camera that is selectively positioned to acquire an image of a player actively using the gaming machine and/or the surrounding area of the gaming machine. The sensor may be configured to capture biometric data about a player in proximity to the gaming machine. The biometric data may be used to implement mechanical and/or digital adjustments to the gaming machine. Alternately, or additionally, the sensor may be configured to selectively acquire still or moving (e.g., video) images. The display devices may be configured to display the image acquired by the camera as well as display the visible manifestation of the game in split screen or picture-in-picture fashion. For example, the camera may acquire an image of the player and the processor may incorporate that image into the primary and/or secondary game as a game image, symbol, animated avatar, or game indicia. In some implementations, the sensor may be used to trigger an attract mode effect. For example, when the sensor detects the presence of a nearby player, the gaming machine may play sound effects or display images, text, graphics, lighting effects, or animations to attract the player to play a game at the gaming machine.

Gaming machine 2 is but one example from a wide range of gaming machine designs on which the techniques described herein may be implemented. For example, not all suitable gaming machines have top boxes or player tracking features. Further, some gaming machines have only a single game display—mechanical or video, while others may have multiple displays.

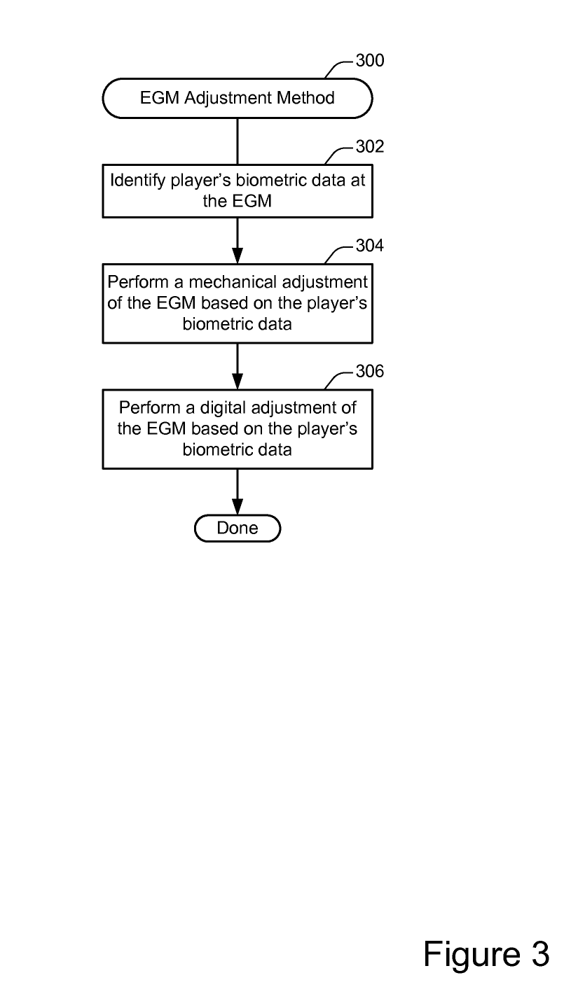

FIG. 3 shows a flow diagram of a method 300 for adjusting an electronic gaming machine, performed in accordance with one implementation. In some implementations, the method 300 may be performed at a master gaming controller or other centralized control unit at an electronic gaming machine. The centralized control unit may be in communication with other components at the electronic gaming machine, such as sensors, network controllers, displays, and mechanical actuators.

At 302, biometric data of a player at the gaming machine is identified. In some implementations, various types of biometric data may be identified. For example, a player's skin temperature or facial expressions may be determined. As another example, spatial coordinates for a player's head, eyes, ears, or other features may be determined. As yet another example, orientation data for a player's head, eyes, ears, or other features may be determined.

In some implementations, identifying the player's biometric data may include receiving sensor data from one or more sensors at the gaming machine. The sensors at the gaming machine may include one or more optical sensors, infrared sensors, weight sensors, pressure sensors, ultrasonic sensors, or any other type of sensors.

In some implementations, identifying the player's biometric data may include receiving the biometric data from a storage medium. For example, the player's biometric data may be stored on a player tracking card inserted into the electronic gaming machine. As another example, the player's biometric data may be transmitted to the electronic gaming machine via a network.

In some implementations, identifying the player's biometric data may include estimating some biometric data based on other biometric data. For example, sensors may be used to determine a player's approximate height or head location. Then, spatial coordinates defining a location of the player's eyes may be estimated based on the player's approximate height or head location. As another example, sensors may be used to determine a player's skin temperature or facial expressions. Based on this data, an estimate of the player's mood or temperament may be determined.

In some implementations, identifying the player's biometric data may include receiving input from the player. For example, the player may be asked to indicate the player's height. As another example, the player may indicate a mechanical or digital adjustment for the gaming machine to implement. As yet another example, the player may indicate a mechanical or digital adjustment overriding an automatic mechanical or digital adjustment made by the gaming machine.

At 304, a mechanical adjustment of the electronic gaming machine is performed. In some implementations, the mechanical adjustment of the electronic gaming machine may include any adjustment of a physical location or orientation of any mechanically adjustable component at the electronic gaming machine. In some instances, more than one mechanical adjustment may be performed.

In some implementations, the mechanical adjustments to perform may be determined based at least in part on the player's biometric data identified at operation 302. The determination may involve identifying a mechanical adjustment to make the gaming machine more accessible or attractive to a person having the biometric data identified at operation 302. For example, such operations may include causing audio or video information to be trained more directly on the player. As another example, such operations may include adjusting the electronic gaming machine to better suit the player's ergonomic needs.

In some implementations, the mechanical adjustments may include moving a display screen. For example, the display screen may be moved up, down, left, or right. As another example, the display screen may be rotated or tilted. As yet another example, the display screen may be moved in a direction normal to the electronic gaming machine screen toward a player or away from a player.

In some implementations, the mechanical adjustments may include moving a speaker. For example, a speaker may be moved or tilted as discussed with respect to the display screen. The speaker may be moved or tilted to move a preferred listening area for the speakers to an estimated location of the player's head.

In some implementations, other types of mechanical adjustments may be performed. For example, a player's seat position or orientation may be automatically adjusted. As another example, a position or orientation of a button panel or other user input device may be automatically adjusted. As yet another example, a height or position of the gaming machine stand may be adjusted.

At 306, a digital adjustment of the electronic gaming machine is performed. In some implementations, the digital adjustment of the electronic gaming machine may be based at least in part on the player's biometric data identified at operation 302. The digital adjustment of the electronic gaming machine may include any adjustments to the input of visual, auditory, or tactile components at the electronic gaming machine that cause these components to alter their output. In some instances, more than one digital adjustment may be performed.

In some implementations, the digital adjustments to perform may be determined based at least in part on the player's biometric data identified at operation 302. The determination may involve identifying a digital adjustment to make the gaming machine more accessible or attractive to a person having the biometric data identified at operation 302. For example, such operations may include causing audio or video information to be trained more directly on the player. As another example, such operations may include adjusting the electronic gaming machine to better suit the player's ergonomic needs.

In some implementations, the digital adjustments may include moving video or image data displayed on a display screen. For example, an emphasized portion of the video or image data may be moved to a portion of the display screen central to the player's estimated field of vision based on the player's height, eye location, or head location. As another example, a de-emphasized portion of the video or image data may be moved to a portion of the display screen that is less central to the player's estimated field of vision. As yet another example, an emphasized portion of the video or image data may be enlarged or reduced in size based on the distance between the player and the electronic gaming machine.

In some implementations, the digital adjustments may include presenting an image or video to the player. For example, the gaming machine may position a position a notice such as “LOOK UP” directly in front of a player's head location and/or orientation during a game play stage or a bonus stage in which information is displayed on the top box.

In some implementations, the digital adjustments may include adjusting the audio input to a speaker. For example, the volume may be raised or lowered. As another example, some speakers (e.g., default speakers) may be deactivated or reduced in volume, while other speakers (e.g., low or high speakers) may be activated or increased in volume.

In some implementations, other types of digital adjustments may be performed. For example, lighting positioned on the gaming machine may be altered.

In some implementations, the mechanical or digital adjustments discussed with respect to FIG. 3 may be determined by comparing biometric data to predetermined tables or charts of ergonomic relationships. Alternately, or additionally, the mechanical or digital adjustments may be determined dynamically.

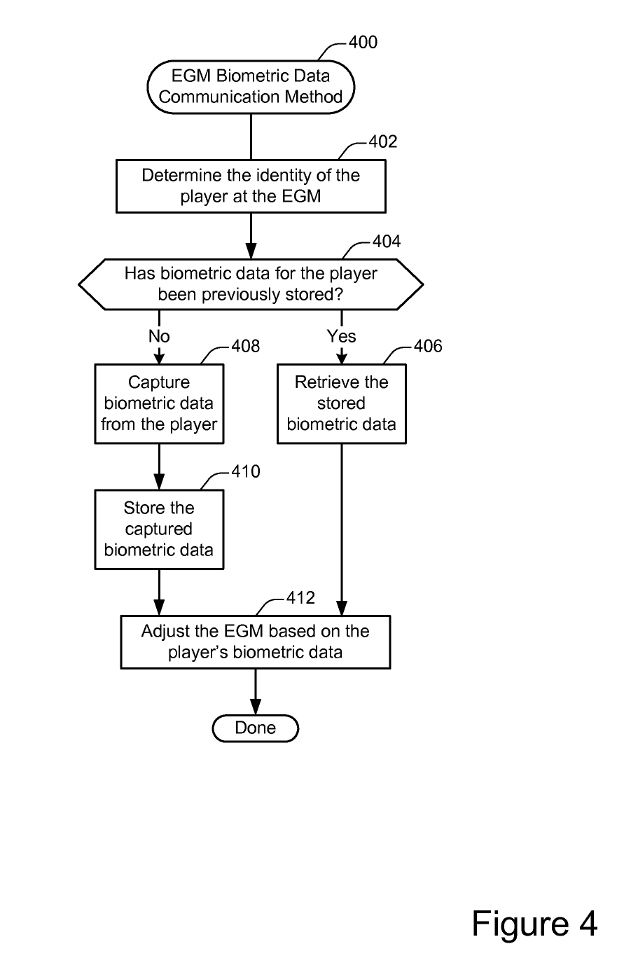

FIG. 4 shows a flow diagram of a method 400 for communicating biometric data at an electronic gaming machine, performed in accordance with one implementation. In some implementations, the method 400 may be performed at an electronic gaming machine. The electronic gaming machine may be in communication with a storage medium directly or via a network.

In some implementations, the method 400 may be used to associate a player's identity with biometric data. The biometric data may be used to adjust the electronic gaming machine to the player's characteristics such as height. In some instances, the biometric data may be determined at the electronic gaming machine and stored on a storage medium. In other instances, biometric data that was previously recorded may be retrieved once the player's identity is known at the electronic gaming machine.

In some implementations, player height or other biometric data may be assigned as a variable included with player tracking data. In some cases, this data may be captured at the electronic gaming machine. Alternately, or additionally, data may be associated with the player tracking account when the account is created or modified at a location other than the electronic gaming machine. The player's height may be used, for example, to compute the approximate location of the player's head relative to the electronic gaming machine. Then, the electronic gaming machine may be adjusted in accordance with the approximate head location.

In some implementations, various types of biometric data may be captured, retrieved, stored, and used as discussed with respect to the method 400. This data may include, but is not limited to, height data, skin temperature data, and preferred gaming machine settings.

At 402, the identity of the player at the electronic gaming machine is determined. In some implementations, the player's identity may be determined based on a player tracking card or portable electronic device in communication with the electronic gaming machine. Alternately, or additionally, the player may provide identification information such as a player tracking number, user name, or password.

At 404, a determination is made as to whether biometric data for the player has been previously stored. In some implementations, the determination made at 404 may be made at least in part based on information stored on a player tracking card or portable electronic device in communication with the electronic gaming machine. For instance, the electronic gaming machine may read a player tracking card to determine whether the card includes the biometric data.

In some implementations, the determination made at 404 may be made at least in part based on communications with a remote server. For instance, the electronic gaming machine may transmit an indication of the player's identity to a remote server. In response, the remote server may transmit the player's biometric data or an indication that no such data is associated with the player's tracking number.

At 406, the stored biometric data is retrieved. For example, the biometric data may be read from a player tracking card. As another example, the biometric data may be received from a remote server via a network.

At 408, biometric data from the player is captured. In some implementations, the biometric data may be captured by receiving data from one or more sensors at the electronic gaming machine. For example, one or more cameras, optical sensors, infrared sensors, fingerprint scanners, weight sensors, pressure sensors, or any other sensors may be used to detect information about the player.

In some implementations, the biometric data captured at 408 may include any biometric data capable of being identified or determined at the electronic gaming machine. For instance, the biometric data may include an orientation or location of the player's head, eyes, ears, or other facial features. As another example, the biometric data may include the player's height, weight, age, or other such information. As yet another example, the biometric data may include a retina scan, a fingerprint scan, or other such unique identification data.

In some implementations, the biometric data captured at 408 may be used to make various determinations about the player at the gaming machine. For example, the player's mood, race, age, sex, or other characteristics may be determined. This data may be stored in association with the player's preferences to identify trends and characteristics of groups of players.

In some implementations, the biometric data may be captured by receiving input from the player. For instance, the player may be asked to enter the player's height, weight, age, or other information at a user input device.

In some implementations, data indicating a degree of confidence in a player's biometric data may be stored on a server. For instance, a player's height may be estimated differently at different gaming machines. The degree of confidence may be based on an amount of variance in the captured biometric data.

At 410, the captured biometric data is stored. In some implementations, the data may be stored at a storage device local to the electronic gaming machine. For instance, the data may be stored to the player's smart card, player tracking card, or portable electronic device. As another example, the data may be stored at a storage medium within the electronic gaming machine.

In some implementations, the data may be stored at a remote storage device. For instance, the data may be transmitted to a remote server via a network. At the server, the data may be stored in association with the player's tracking account.

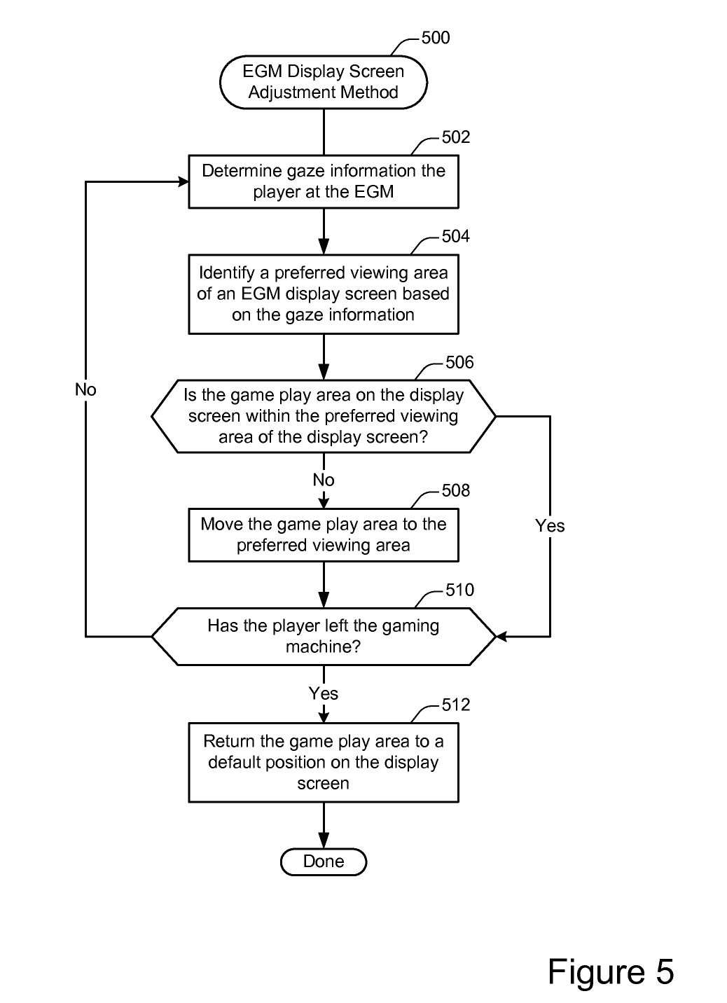

At 412, the electronic gaming machine may be adjusted based on the player's biometric data. In some implementations, the electronic gaming machine may be adjusted as discussed with respect to operations 304 and 306 shown in FIG. 3 or as discussed with respect to the method 500 shown in FIG. 5.

In some implementations, biometric data for the player may be captured even if biometric data for the player has been previously stored. For instance, new biometric data may be captured for comparison against previously stored biometric data. As another example, if the player manually overrides automatic electronic gaming machine adjustments, the player's preferences may be stored.

FIG. 5 shows a flow diagram of a method 500 for adjusting a display screen at an electronic gaming machine, performed in accordance with one implementation. In some implementations, the method 500 may be used to adjust the display screen based on the player's biometric data. For instance, location and/or orientation data may be determined for a player's head, eyes, or other facial features.

In some implementations, the method 500 may be used to present a game play area or other emphasized portion of information presented on a display screen in a preferred viewing area on the display screen. The preferred viewing area may be a region of the display screen estimated to be relatively central within the player's field of vision. Variations in player height and build result in variations of the height of a particular player's head when seated at the gaming machine, which may affect the image the player sees on the display screen. The distance of the player from the machine and the orientation of the player's head or eyes may also affect the image the player sees on the display screen.

At 502, gaze information is determined for the player at the electronic gaming machine. The gaze information may identify a location and/or orientation of the player's gaze toward the electronic gaming machine. In some implementations, the gaze information may be based on the player's head. Alternately, or additionally, the gaze information may be based on the player's eyes.

In some implementations, the gaze information may be identified via any available sensors at the electronic gaming machine. For instance, the gaze information may be identified via a camera, an optical sensor, an infrared sensor, or any other sensor capable of identifying the location and/or orientation information.

In some implementations, location data may be gathered for the player's head or eyes. The location data may specify spatial coordinates that define the location in space of the player's head or eyes with respect to the gaming machine. For example, the height data may include a vertical dimension or “Y” axis with respect to the floor. The height data may also include a horizontal dimension or “X” axis defining a distance from the gaming machine. The height data may also include a lateral dimension or “Z” axis defining a left-to-right position in front of the gaming machine.

In some implementations, orientation data may be gathered for the player's head or eyes. The orientation data may indicate an angle at which the head is tilted or the eyes are focused. The location data may include a vertical angle “V” that defines an angle above or below the horizontal dimension or “X” axis that is normal to the gaming machine. The location data may also include a lateral angle “H” that defines an angle that is left or right of the horizontal dimension or “X” axis that is normal to the gaming machine.

At 504, a preferred viewing area of the electronic gaming machine display screen is identified based on the player's gaze information. In some implementations, the preferred viewing area may be located directly in front of the player's head or eye location, as determined at operation 502. Alternately, or additionally, the preferred viewing area may be located in an area of the electronic gaming machine being viewed by the player based on the orientation of the player's head or eyes, as determined at operation 502.

At 506, a determination is made as to whether the game play area or any other emphasized information displayed on the display screen is positioned within the preferred viewing area. In some implementations, the emphasized information may include game play outcomes, game play control functions, bonus information, player tracking information, or any other information deemed important. The current position of the emphasized information may be a default position, a position based on a previous determination of the player's gaze information, a position based on gaze information determined for a different player, or any other position on the display screen.

At 508, the game play area or other emphasized information is moved to the preferred viewing area of the display screen. The emphasized information may be moved quickly, slowly, or in any manner deemed appropriate. By positioning the emphasized information within the preferred viewing area, the player's attention may be drawn to the emphasized information. Alternately, or additionally, the electronic gaming machine may be made to better suit the player's ergonomic needs by displaying important information in a location most comfortably visible to the player.

In some implementations, a determination may be made as to whether the player is looking at the main screen when a bonus animation or game is playing on the top box. If the player is not looking at the top box, then the player may be presented with a message directing the player's attention to the top box display area.

In some implementations, a determination may be made as to the player's proximity to the gaming machine. If the player is sitting quite close to the gaming machine, the game play area may be reduced in size. Alternately, if the player is sitting quite close to the gaming machine, the game play area may be increased in size.

In some implementations, the player's gaze information may be used to simulate, in two dimensions, a three dimensional visual effect. For example, the gaming machine may alter the image displayed on the display screen to track the player's gaze.

At 510, a determination is made as to whether the player has left the gaming machine. In some implementations, the determination at 510 may be made at least in part based on the player's actions with respect to the electronic gaming machine. For instance, the player may cash out, remove a player tracking card, log off, or provide some other indication that the player is leaving the electronic gaming machine.

In some implementations, the determination at 510 may be made at least in part based on sensor data determined at the electronic gaming machine. For instance, an optical or infrared sensor configured to detect a player's head location or skin temperature may return a value indicating that the player is no longer located in front of the electronic gaming machine.

At 512, the game play area is returned to a default position on the display screen. In some implementations, the game play area may be presented in a default position whenever a player is not detected at the electronic gaming machine. By presenting the game play area in a default position, the electronic gaming machine may adopt a uniform appearance when compared to other, proximately located electronic gaming machines.

In some implementations, the player may be able to override automatic operations at the electronic gaming machine. For example, the player may be able to specify a preferred viewing area at 504. As another example, the player may be able to adjust the position of the game play area before or after it is moved at operation 508. As yet another example, the player may be presented with a message asking whether the player would like the gaming machine to auto-adjust.

In some implementations, the game play area may not be returned to a default position. In this way, the adjustability of the electronic gaming machine may be made apparent to players walking nearby.

In some implementations, information identified via method 500, such as the player's head or eye location, the player's head or eye orientation, or the preferred viewing area, may be stored in association with information identifying the player. Techniques for communicating biometric data are discussed with respect to the method 400 shown in FIG. 4.

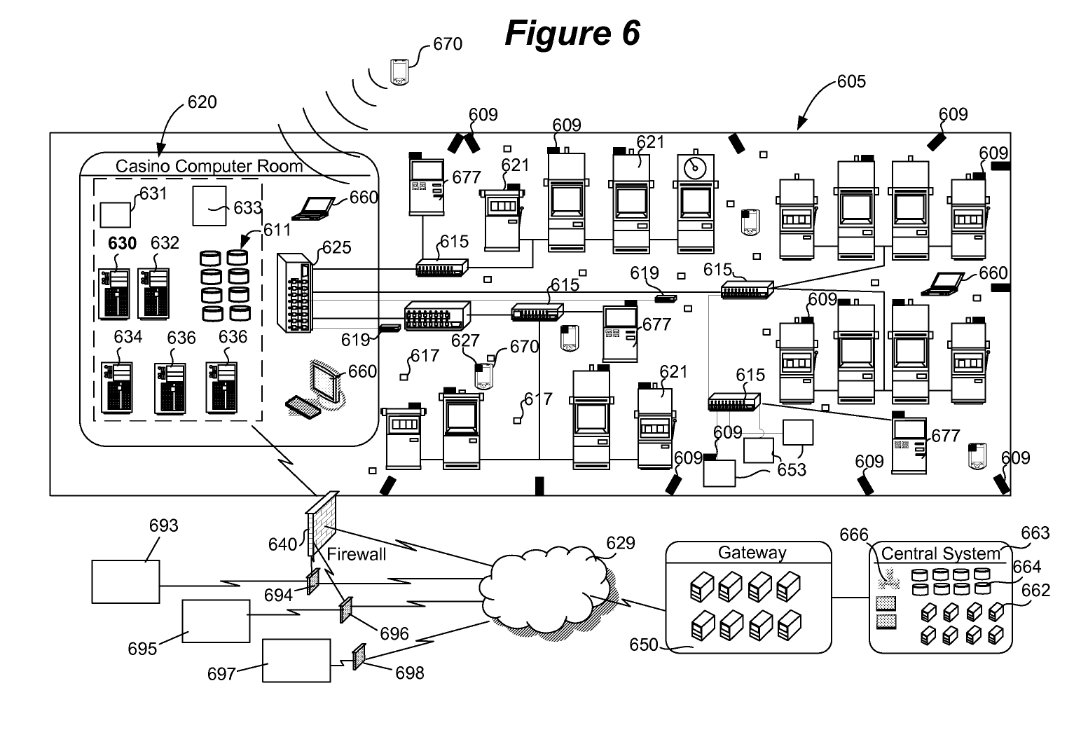

FIG. 6 shows a server-based (Sb™) gaming network, configured in accordance with some implementations. Those of skill in the art will realize that this architecture and the related functionality are merely examples and that the present disclosure encompasses many other such embodiments and methods.

Here, casino computer room 620 and networked devices of a gaming establishment 605 are illustrated. Gaming establishment 605 is configured for communication with central system 663 via gateway 650. Gaming establishments 693 and 695 are also configured for communication with central system 663.

In some implementations, gaming establishments may be configured for communication with one another. In this example, gaming establishments 693 and 695 are configured for communication with casino computer room 620. Such a configuration may allow devices and/or operators in casino 605 to communicate with and/or control devices in other casinos. In some such implementations, a server in computer room 620 may control devices in casino 605 and devices in other gaming establishments. Conversely, devices and/or operators in another gaming establishment may communicate with and/or control devices in casino 605.

For example, a server of casino 605 or central system 663 may be provisioned with relatively more advanced software (e.g., 3-D facial recognition software) for patron identification than servers of other networked locations. Such a server may process patron identification requests from devices in casino 605 as well as patron identification requests from devices in gaming establishments 693 and 695.

Here, gaming establishment 697 is configured for communication with central system 663, but is not configured for communication with other gaming establishments. Some gaming establishments (not shown) may not be in communication with other gaming establishments or with a central system. Gaming establishment 605 includes multiple gaming machines 621, each of which is part of a bank 610 of gaming machines 621. In this example, gaming establishment 605 also includes a bank of networked gaming tables 653. However, the present disclosure may be implemented in gaming establishments having any number of gaming machines, gaming tables, etc. It will be appreciated that many gaming establishments include hundreds or even thousands of gaming machines 621 and/or gaming tables 653, not all of which are necessarily included in a bank and some of which may not be connected to a network. At least some of gaming machines 621 and/or mobile devices 670 may be “thin clients” that are configured to perform client-side methods as described elsewhere herein.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 653 may be configured for communication with individual player terminals (not shown), which may be configured to accept bets, present an electronic representation of a dealer, indicate game outcomes, etc.

Gaming establishment 605 also includes networked kiosks 677. Depending on the implementation, kiosks 677 may be used for various purposes, including but not limited to cashing out, prize redemption, redeeming points from a player loyalty program, redeeming “cashless” indicia such as bonus tickets, smart cards, etc. In some implementations, kiosks 677 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present disclosure. For example, in some implementations of the disclosure, kiosks 677 may be configured to receive information from a patron, e.g., by presenting graphical user interfaces.

In this example, each bank 610 has a corresponding switch 615, which may be a conventional bank switch in some implementations. Each switch 615 is configured for communication with one or more devices in computer room 620 via main network device 625, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various embodiments of the disclosure. IGT has also developed a gaming-industry-specific transport layer called CASH that rides on top of TCP/IP and offers additional functionality and security.

Here, gaming establishment 605 also includes an RFID network, implemented in part by RFID switches 619 and multiple RFID readers 617. An RFID network may be used, for example, to track objects (such as mobile gaming devices 670, which include RFID tags 627 in this example), patrons, etc., in the vicinity of gaming establishment 605.

As noted elsewhere herein, some implementations of the disclosure may involve “smart” player loyalty instruments, such as player tracking cards, which include an RFID tag. Accordingly, the location of such RFID-enabled player loyalty instruments may be tracked via the RFID network. In this example, at least some of mobile devices 670 may include an RFID tag 627, which includes encoded identification information for the mobile device 670. Accordingly, the locations of such tagged mobile devices 670 may be tracked via the RFID network in gaming establishment 605. Other location-detection devices and systems, such as the global positioning system (“GPS”), may be used to monitor the location of people and/or devices in the vicinity of gaming establishment 605 or elsewhere.

Various alternative network topologies can be used to implement different embodiments of the disclosure and/or to accommodate varying numbers of networked devices. For example, gaming establishments with large numbers of gaming machines 621 may require multiple instances of some network devices (e.g., of main network device 625, which combines switching and routing functionality in this example) and/or the inclusion of other network devices not shown in FIG. 6. Some implementations of the disclosure may include one or more middleware servers disposed between kiosks 677, RFID switches 619 and/or bank switches 615 and one or more devices in computer room 620 (e.g., a corresponding server). Such middleware servers can provide various useful functions, including but not limited to the filtering and/or aggregation of data received from switches, from individual gaming machines and from other devices. Some implementations of the disclosure include load-balancing methods and devices for managing network traffic.

Storage devices 611, Sb™ server 630, License Manager 631, Arbiter 633, servers 632, 634, 636 and 638, host device(s) 660 and main network device 625 are disposed within computer room 620 of gaming establishment 605. In practice, more or fewer devices may be used. Depending on the implementation, some such devices may reside in gaming establishment 605 or elsewhere.

One or more devices in central system 663 may also be configured to perform, at least in part, tasks specific to the present disclosure. For example, one or more servers 662, arbiter 633, storage devices 664 and/or host devices 660 of central system 663 may be configured to implement the functions described in detail elsewhere herein. These functions may include, but are not limited to, providing functionality for devices such as wager gaming machines 621, mobile devices 670, etc.

One or more of the servers of computer room 620 may be configured with software for receiving a player's wager gaming notification parameters, determining when a wagering condition corresponds with the wager gaming notification parameters and/or providing a notification to the player when the wagering condition corresponds with the wager gaming notification parameters. Moreover, one or more of the servers may be configured to receive, process and/or provide image data from cameras 609, to provide navigation data to patrons (e.g., to indicate the location of and/or directions to a gaming table, a wager gaming machine, etc., associated with a wager gaming notification), etc.

For example, navigation data (which may include map data, casino layout data, camera image data, etc.) may be provided by one or more of the servers of computer room 620 to mobile devices 670. Some implementations of the present disclosure include a plurality of networked cameras 609, which may be video cameras, smart cameras, digital still cameras, etc. In some such implementations, such cameras may provide, at least in part, real-time navigation.

Other devices that may be deployed in network 605 do not appear in FIG. 6. For example, some gaming networks may include not only various radio frequency identification (“RFID”) readers 617, but also RFID switches, middleware servers, etc., some of which are not depicted in FIG. 6. These features may provide various functions. For example, a server (or another device) may determine a location of a mobile device 670 according to the location of an RFID reader that reads an RFID tag 627.

The servers and other devices indicated in FIG. 6 may be configured for communication with other devices in or outside of gaming establishment 605, such as host devices 660, kiosks 677 and/or mobile devices 670, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the disclosure provide one or more of these servers in the form of blade servers.

Some embodiments of Sb™ server 630 and the other servers shown in FIG. 6 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the disclosure, many of these devices (including but not limited to License Manager 631, servers 632, 634, 636, and 638, and main network device 625) are mounted in a single rack with Sb™ server 630. Accordingly, many or all such devices will sometimes be referenced in the aggregate as an “Sb™ server.” However, in alternative implementations, one or more of these devices is in communication with Sb™ server 630 and/or other devices of the network but located elsewhere. For example, some of the devices could be mounted in separate racks within computer room 620 or located elsewhere on the network. Moreover, it can be advantageous to store large volumes of data elsewhere via a storage area network (“SAN”).

Computer room 620 may include one or more operator consoles or other host devices that are configured for communication with other devices within and outside of computer room 620. Such host devices may be provided with software, hardware and/or firmware for implementing various embodiments of the disclosure. However, such host devices need not be located within computer room 620. Wired host devices 660 (which are desktop and laptop computers in this example) and wireless devices 670 (which are PDAs in this example) may be located elsewhere in gaming establishment 605 or at a remote location.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

Any of the above embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While various embodiments have been described herein, it should be understood that they have been presented by way of example only, and not limitation. Thus, the breadth and scope of the present application should not be limited by any of the embodiments described herein, but should be defined only in accordance with the following and later-submitted claims and their equivalents.

What is claimed is:

1. An electronic gaming machine comprising:
an input device configured to receive an indication of value for play of a wager-based game in which one or more game outcomes can be provided responsive to a wager;
an output device configured to output an indication of value in association with play of the wager-based game;
a display screen configured to display video data associated with the wager-based game;
an electronic sensor configured to determine a spatial coordinate of an eye area of a player in proximity to the electronic gaming machine, the spatial coordinate defining a location of the eye area in relation to the electronic gaming machine;
one or more processors configured to:
control play of the wager-based game;
provide the video data to the display screen;
determine, based on the spatial coordinate, a preferred viewing area of the display screen;
determine whether a game play portion of the video data is positioned within the preferred viewing area of the display screen; and
when the game play portion of the video data is not positioned within the preferred viewing area of the display screen, position the game play portion of the video data within the preferred viewing area of the display screen.

2. The electronic gaming machine recited in claim 1, wherein the spatial coordinate includes an indication of a height of the eye area.

3. The electronic gaming machine recited in claim 1, wherein the spatial coordinate includes an indication of a location of the eye area in three dimensional space in relation to the electronic gaming machine.

4. The electronic gaming machine recited in claim 1, wherein the one or more processors is further configured to:
determine whether the player has left the proximity of the electronic gaming machine; and
when the player has left the proximity of the electronic gaming machine, position the game play portion of the video data at a default position on the display screen.

5. The electronic gaming machine recited in claim 1, wherein the one or more processors is further configured to:
determine, based on the spatial coordinate, a preferred mechanical position of a mechanically adjustable portion of the electronic gaming machine; and
position the mechanically adjustable portion of the electronic gaming machine at the preferred mechanical position.

6. The electronic gaming machine recited in claim 1, wherein determining the spatial coordinate for the eye area comprises:
determining a location of the player's head; and
determining an orientation of the player's head.

7. The electronic gaming machine recited in claim 1, wherein the one or more processors is further configured to:
determine a height estimate of the player's height based on the spatial coordinate; and
transmit the height estimate to be stored on a storage medium.

8. The electronic gaming machine recited in claim 1, wherein the electronic sensor is an optical sensor.

9. A method comprising:
determining a spatial coordinate of an eye area of a player in proximity to the electronic gaming machine, the spatial coordinate defining a location of the eye area in relation to the electronic gaming machine, the electronic gaming machine configured to receive an indication of value for play of a wager-based game in which one or more game outcomes can be provided responsive to a wager, the electronic gaming machine configured to output an indication of value in association with play of the wager-based game, the wager-based game provided in accordance with instructions stored on one or more non-transitory computer readable media;
determining, based on the identified eye location, a preferred viewing area of a display screen associated with the electronic gaming machine, the display screen displaying video data associated with the wager-based game;
determining whether a game play portion of the video data is positioned within the preferred viewing area of the display screen; and
when the game play portion of the video data is not positioned within the preferred viewing area of the display screen, positioning the game play portion of the video data within the preferred viewing area of the display screen.

10. The method recited in claim 9, wherein the spatial coordinate includes an indication of a height of the eye area.

11. The method recited in claim 9, wherein the spatial coordinate includes an indication of a location of the eye area in three dimensional space in relation to the electronic gaming machine.

12. The method recited in claim 9, the method further comprising:
determine whether the player has left the proximity of the electronic gaming machine; and
when the player has left the proximity of the electronic gaming machine, position the game play portion of the video data at a default position on the display screen.

13. The method recited in claim 9, the method further comprising:
determining, based on the spatial coordinate, a preferred mechanical position of a mechanically adjustable portion of the electronic gaming machine; and
positioning the mechanically adjustable portion of the electronic gaming machine at the preferred mechanical position.

14. The method recited in claim 9, wherein determining the spatial coordinate for the eye area comprises:
determining a location of the player's head; and
determining an orientation of the player's head.

15. The method recited in claim 9, the method further comprising:
determine a height estimate of the player's height based on the spatial coordinate; and
transmit the height estimate to be stored on a storage medium.

16. The method recited in claim 9, wherein determining the spatial coordinate comprises retrieving an indication of the player's height from a storage medium.

17. One or more non-transitory computer readable media having instructions stored thereon for performing a method, the method comprising:
determining a spatial coordinate of an eye area of a player in proximity to the electronic gaming machine, the spatial coordinate defining a location of the eye area in relation to the electronic gaming machine, the electronic gaming machine configured to receive an indication of value for play of a wager-based game in which one or more game outcomes can be provided responsive to a wager, the electronic gaming machine configured to output an indication of value in association with play of the wager-based game;
determining, based on the identified eye location, a preferred viewing area of a display screen associated with the electronic gaming machine, the display screen displaying video data associated with the wager-based game;
determining whether a game play portion of the video data is positioned within the preferred viewing area of the display screen; and
when the game play portion of the video data is not positioned within the preferred viewing area of the display screen, positioning the game play portion of the video data within the preferred viewing area of the display screen.

18. The one or more computer readable media recited in claim 17, wherein the spatial coordinate includes an indication of a height of the eye area.

19. The one or more computer readable media recited in claim 17, wherein the spatial coordinate includes an indication of a location of the eye area in three dimensional space in relation to the electronic gaming machine.

20. The one or more computer readable media recited in claim 17, the method further comprising:
determine whether the player has left the proximity of the electronic gaming machine; and
when the player has left the proximity of the electronic gaming machine, position the game play portion of the video data at a default position on the display screen.
